(19) United States
(12) Patent Application Publication
(10) Pub. No.: US 2017/0191587 A1
(43) Pub. Date: Jul. 6, 2017

(54) SPIRAL PIPE GAP JOINT

(71) Applicants: Craig LAPINE, Portage, MI (US); Robert DEPIERRE, Clarkston, MI (US)

(72) Inventors: Craig LAPINE, Portage, MI (US); Robert DEPIERRE, Clarkston, MI (US)

(21) Appl. No.: 14/986,984

(22) Filed: Jan. 4, 2016

(51) Int. Cl. F16L 21/00

(52) U.S. Cl. CPC F16L 21/002

(57) ABSTRACT

A pipe gap assembly including an insert sleeve and an adjustment sleeve. The insert sleeve includes a first side large diameter section, a small diameter section and a second side large diameter section, with the insert sleeve having an insert sleeve enlarged lip at the second side thereof. The adjustment sleeve has a first side, a second side and a cylinder having an outer surface, with the outer surface of cylinder of the adjustment sleeve being smaller than an inner surface of the insert sleeve to allow the first end of the adjustment sleeve to be able to be slid within the insert sleeve. The adjustment sleeve further includes a ring seal surrounding the outer surface thereof. The ring seal is not fixed in position on the outer surface of the adjustment sleeve such that the ring seal is able to roll on the outer surface of the adjustment sleeve.

### FIELD OF THE INVENTION

The present invention relates to a ducting, and in particular to gap joint between a pair of ducts.

### BACKGROUND OF THE INVENTION

Ducts are used in residential and commercial settings to route air and sometimes particles in air from an initial location to another location. Presently, during installation of ducts, multiple sections of ducts are connected together to complete a duct system. Duct sections generally arrive at a job site in standard lengths and require final fitting during installation. The final fitting can involve cutting one section of duct for a proper fit to an adjacent section of duct, adding a flange or ring, inserting the cut section into a mating section of duct with screws, and finally sealing with duct tape. All of the current methods are time consuming and often result in a joint which is not completely sealed.

A fast, easy and reliable method of connecting duct sections is desired.

### SUMMARY OF THE INVENTION

The present invention, according to one aspect, is directed to a pipe gap assembly including an insert sleeve and an adjustment sleeve. The insert sleeve has a first side and a second side. The insert sleeve includes a first side large diameter section, a small diameter section and a second side large diameter section, with the insert sleeve having an insert sleeve enlarged lip at the second side thereof. The adjustment sleeve has a first side and a second side. The adjustment sleeve includes a cylinder having an outer surface, with the outer surface of cylinder of the adjustment sleeve being smaller than an inner surface of the second side large diameter section of the insert sleeve to allow the first end of the adjustment sleeve to be able to be slid within the second side large diameter section of the insert sleeve. The adjustment sleeve further includes a ring seal surrounding the outer surface thereof. The ring seal is not fixed in position on the outer surface of the adjustment sleeve such that the ring seal is able to roll on the outer surface of the adjustment sleeve.

Another aspect of the present invention is to provide a pipe gap joint including a first pipe having a first pipe cylinder and a cylindrical edge, a second pipe having a second pipe cylinder and a rolled edge, an insert sleeve and an adjustment sleeve. The insert sleeve has a first side inserted into the first pipe at the cylindrical edge and a second side. The insert sleeve includes a first side large diameter section, a small diameter section and a second side large diameter section, with the insert sleeve having an insert sleeve enlarged lip at the second side thereof. The adjustment sleeve has a first side inserted into the second side of the insert sleeve and a second side. The adjustment sleeve includes a cylinder having an outer surface and an adjustment sleeve enlarged lip at the second side thereof. The adjustment sleeve enlarged lip abuts the rolled edge of the second pipe. The adjustment sleeve further includes a ring seal surrounding the outer surface of the cylinder thereof. The ring seal is not fixed in position on the outer surface of the adjustment sleeve such that the ring seal is able to roll on the outer surface of the adjustment sleeve, the ring seal abutting the insert sleeve enlarged lip.

Yet another aspect of the present invention is to provide a method of forming a pipe gap joint including providing a first whole pipe having a first whole pipe cylinder and a pair of first pipe rolled edges, cutting the first whole pipe to form a pair of first cut pipes, with each of the first cut pipes including a cylindrical cut edge, providing a second pipe having a second pipe cylinder and a second pipe rolled edge, providing an insert sleeve having a first side and a second side, with the insert sleeve including a first side large diameter section, a small diameter section and a second side large diameter section, and with the insert sleeve having an insert sleeve enlarged lip at the second side thereof, inserting the first side of the insert sleeve into the first cut pipe at the cylindrical cut edge, providing an adjustment sleeve having a first side and a second side, with the adjustment sleeve including a cylinder having an outer surface and an adjustment sleeve enlarged lip at the second side thereof, inserting the first side of the adjustment sleeve into the second side of the insert sleeve, providing the adjustment sleeve with a ring seal surrounding the outer surface of the cylinder thereof, rolling the ring seal on the outer surface of the adjustment sleeve until the ring seal abuts the insert sleeve enlarged lip, and abutting the adjustment sleeve enlarged lip with the second pipe rolled edge.

### BRIEF DESCRIPTION OF THE DRAWINGS

One or more embodiments of the present invention are illustrated by way of example and should not be construed as being limited to the specific embodiments depicted in the accompanying drawings, in which like reference numerals indicate similar elements.

FIG. 1 is a side view of a pipe gap joint of the present invention, with clamps being shown in cross-section.

FIG. 2 is an exploded side view of a pipe gap joint of the present invention.

FIG. 3 is a side view of a whole duct of the present invention.

FIG. 4 is a side view of the whole duct of the present invention cut into two pieces.

FIG. 5 is a side view of an insert sleeve inserted into a duct of the present invention.

FIG. 6 is a side view of an adjustment sleeve of the present invention.

FIG. 7 is a side view of a duct and a pipe gap assembly of the present invention.

The specific devices and processes illustrated in the attached drawings, and described in the following specification are simply exemplary embodiments of the inventive concepts. Hence, specific dimensions and other physical characteristics relating to the embodiments disclosed herein are not to be considered as limiting.

### DETAILED DESCRIPTION

For purposes of description herein, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

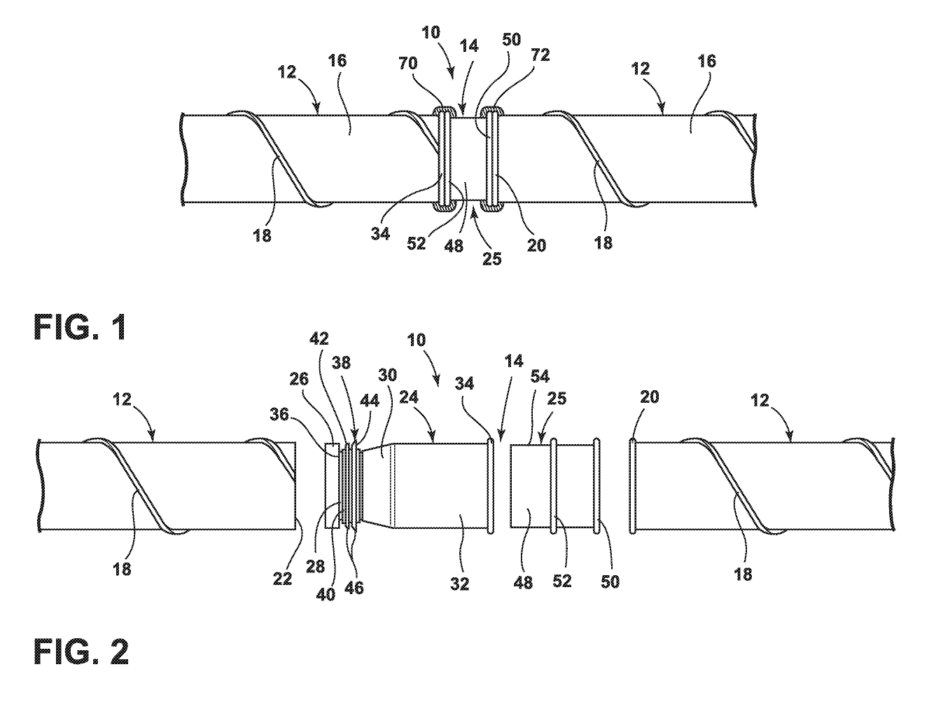

The reference number 10 (FIGS. 1 and 2) generally designates a pipe gap joint of the present invention. The pipe gap joint 10 includes a pair of ducts 12 connected by a pipe gap assembly 14. In duct installations, the ducts 12 come in standard sizes. Typically, the ducts 12 are connected end to end. However, there can be several instances wherein the linear space for the ducts 12 is too large or too small for using whole ducts 12. For example, a space may be fifteen feet long and each of the ducts 12 may be four feet long. Therefore, if four ducts 12 are used, a length of the connected ducts 12 will be one foot too long, and if three ducts 12 are used, a length of the connected ducts 12 will be 3 feet too short. An aspect of the present invention is to provide the pipe gap assembly 14 to cover the space between whole ducts 12 or cover the space between ducts 12 when one of the ducts 12 adjacent the space has been cut to a shorter length.

In the illustrated example, the ducts 12 can be any ducting. As illustrated in FIGS. 1 and 2, each of the ducts 12 is a rolled edge spiral pipe 16. Each rolled edge spiral pipe 16 is cylindrical and includes a circumferential spiral 18 and a rolled collar edge 20 at each end of the rolled edge spiral pipe 16. The rolled edge spiral pipe 16 can be made of any material (e.g., aluminum) and can have any length and diameter. It is contemplated that the ducts 12 could be cylindrical pipe without any spiral 18. In FIGS. 1 and 2, the leftmost rolled edge spiral pipe 16 does not include a rolled collar edge 20 adjacent the pipe gap assembly 14 because the leftmost rolled edge spiral pipe 16 has been cut in a radial direction to a shorter length such that a cut edge 22 of the rolled edge spiral pipe 16 adjacent the pipe gap assembly 14 does not include any rolled collar edge.

The illustrated pipe gap assembly 14 spans the space between a pair of the ducts 12. The pipe gap assembly 14 includes an insert sleeve 24 and an adjustment sleeve 25. As discussed in more detail below, the insert sleeve 24 is inserted into the rolled edge spiral pipe 16 through the end thereof with the cut edge 22 and the adjustment sleeve 25 inserted into the insert sleeve 24 to cover the gap between the ducts 12.

In the illustrated example, the insert sleeve 24 is fit within the rolled edge spiral pipe 16 through the end thereof with the cut edge 22. The insert sleeve 24 includes a left side large diameter section 26, a small diameter seal receiving section 28, a tapering section 30, a right side large diameter section 32 and a rolled edge 34. In the illustrated embodiment, the left side large diameter section 26 and the right side large diameter section 32 have approximately the same diameter. A radial step 36 is located between the left side large diameter section 26 and the small diameter seal receiving section 28. The tapering section 30 is located between the small diameter seal receiving section 28 and the right side large diameter section 32. The rolled edge 34 is located at a right edge of the insert sleeve 24. An outer diameter of the left side large diameter section 26 and the right side large diameter section 32 is slightly smaller than an inner diameter of the rolled edge spiral pipe 16 to allow the insert sleeve 24 to be easily inserted into the rolled edge spiral pipe 16. A terminal end of the left side large diameter section 26 can be rolled or unrolled (as shown). While the present description uses “right” and “left,” such terms are used for description only. The insert sleeve 24 can be rotated 180° such that the “right side” becomes the “left side” and vice versa. Notably, air flows through the insert sleeve 24 from the right side large diameter section 32, to the tapering section 30 and then to the small diameter seal receiving section 28. Therefore, particulates in the air will not get caught on the radial step 36 while flowing through the insert sleeve 24.

The illustrated insert sleeve 24 includes a radially extending seal 38 on an exterior surface of the small diameter seal receiving section 28. The radially extending seal 38 extends radially beyond the left side large diameter section 26 and the right side large diameter section 32 to abut against an inner surface of the rolled edge spiral pipe 16 receiving the insert sleeve 24 therein. In the illustrated example, the radially extending seal 38 includes a cylindrical connection portion 40, a first radially extending disc seal portion 42 extending radially from the cylindrical connection portion 40 and a second radially extending disc seal portion 44 extending radially from the cylindrical connection portion 40. Radially terminal edges 46 of the first radially extending disc seal portion 42 and the second radially extending disc seal portion 44 are beveled in a direction facing an insert direction of the insert sleeve 24 to assist in easy insertion of the insert sleeve 24. It is contemplated that the first radially extending disc seal portion 42 (i.e., the first disc seal portion that will be inserted into the rolled edge spiral pipe 16) can have a smaller diameter than the second radially extending disc seal portion 44. The radially extending seal 38 can be made of any sealing material (e.g., an elastomer such as rubber).

In the illustrated example, the adjustment sleeve 25 is inserted into the insert sleeve 24 and is connected to the rolled collar edge 20 of the adjacent rolled edge spiral pipe 16. The adjustment sleeve 25 includes a cylinder 48 (having straight sides or having a slight taper) and a rolled edge 50. The cylinder 48 includes an outer diameter that is slightly smaller than an inner diameter of the right side large diameter section 32 of the insert sleeve 24 to allow the adjustment sleeve 25 to slide into the insert sleeve 24. The adjustment sleeve 25 includes a ring seal 52 on an outer surface 54 of the cylinder 48. As discussed in more detail below, the ring seal 52 is configured to roll on the outer surface 54 of the cylinder 48 of the adjustment sleeve 25. It is contemplated that the cylinder 48 and the rolled edge 50 can be made of any material (e.g., plastic or metal (such as aluminum or galvanized stainless steel)).

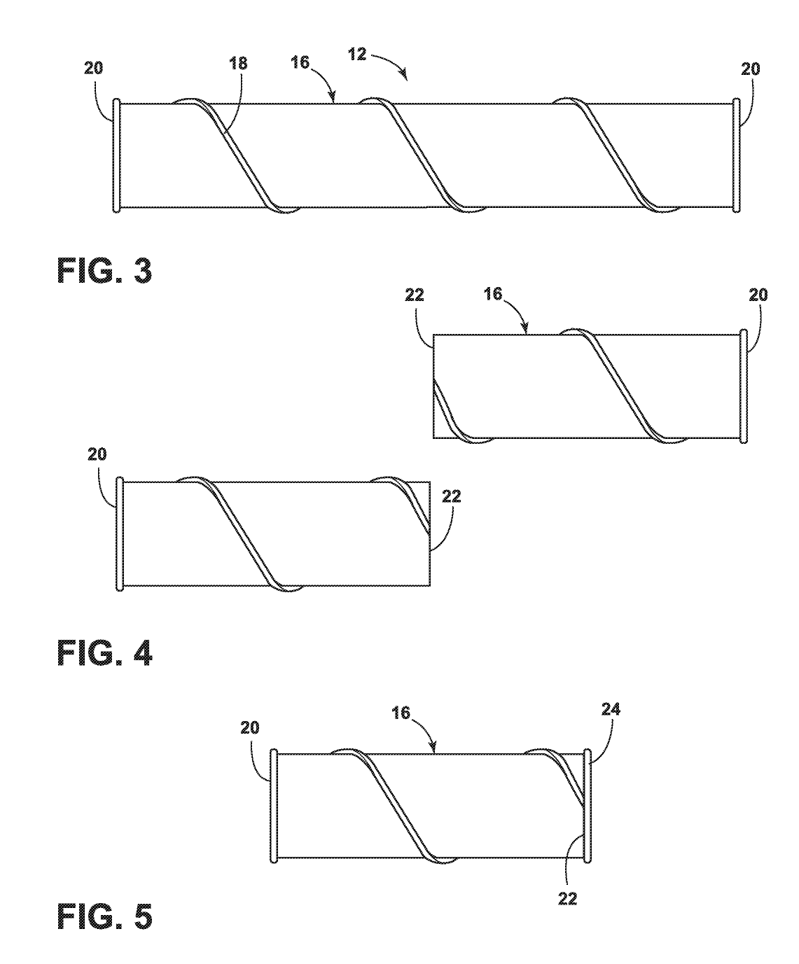

FIGS. 3-7 illustrate steps of constructing the pipe gap joint 10. FIG. 3 illustrates the rolled edge spiral pipe 16 at a full length. As outlined above, a full length rolled edge spiral pipe 16 may be too long to fill in a gap between a pair of rolled edge spiral pipes 16. Therefore, as illustrated in FIG. 4, the rolled edge spiral pipe 16 is cut at an appropriate area along a length thereof to form a pair of rolled edge spiral pipes 16 having a cut edge 22 and a rolled collar edge 20. One of the rolled edge spiral pipes 16 can be used to fill the present gap and the other rolled edge spiral pipe 16 can be used to fill a future gap. After the rolled edge spiral pipe 16 is connected to an adjacent rolled edge spiral pipe 16 (not shown) at the rolled collar edge 20 thereof, the rolled edge spiral pipe 16 is ready to receive the pipe gap assembly 14.

In the illustrated example, a first step of connecting the pipe gap assembly 14 to the rolled edge spiral pipe 16 is to insert the insert sleeve 24 into the end of the rolled edge spiral pipe 16 having the cut edge 22 until the rolled edge 34 of the insert sleeve 24 abuts against the cut edge 22 as illustrated in FIG. 5. The radially extending seal 38 on the exterior surface of the small diameter seal receiving section 28 of the insert sleeve 24 abuts against an inside surface of the rolled edge spiral pipe 16 to keep the insert sleeve 24 in the rolled edge spiral pipe 16. It is contemplated that an adhesive could be applied to the radially extending seal 38, an exterior surface of the insert sleeve 24 and/or an interior surface of the rolled edge spiral pipe 16 to assist in maintaining the insert sleeve 24 within the rolled edge spiral pipe 16.

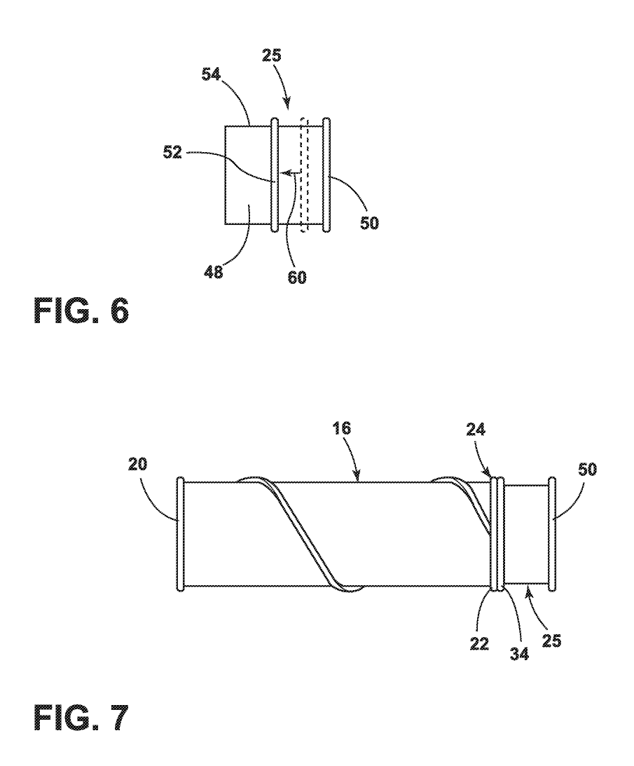

Thereafter, the cylinder 48 of the adjustment sleeve 25 is inserted into the insert sleeve 24 at the rolled edge 34 thereof. The adjustment sleeve 25 is then slid out of the insert sleeve 24 until the rolled edge 50 of the adjustment sleeve 25 abuts against the rolled collar edge 20 of the adjacent rolled edge spiral pipe 16 as illustrated in FIG. 1. At this point, the ring seal 52 is located on the outer surface 54 of the cylinder 48 near the rolled edge 50 of the adjustment sleeve 25 as shown in dashed lines in FIG. 6. The ring seal 52 is then rolled over the outer surface 54 of the cylinder 48 along line 60 as shown in FIG. 6 until the ring seal 52 abuts the rolled edge 34 of the insert sleeve 24. A first clamp 70 (shown in cross-section in FIG. 1) is then fixed in position over the rolled edge 34 of the insert sleeve 24 and the ring seal 52 and a second clamp 72 (shown in cross-section in FIG. 1) is fixed in position over the rolled edge 50 of the adjustment sleeve 25 and the rolled collar edge 20 of the rolled edge spiral pipe 16 as shown in FIG. 1 to fix the pipe gap assembly 14 in position. The first clamp 70 and the second clamp 72 can be any clamp known to those skilled in the art (e.g., ring clamps having an inwardly facing concave groove as shown). Any other appropriate fastening mechanism could also be used.

Although particular preferred embodiments of the invention have been disclosed in detail for illustrative purposes, it will be recognized that variations or modifications of the disclosed apparatus, including the rearrangement of parts, lie within the scope of the present invention.

What is claimed is:

1. A pipe gap assembly comprising:
an insert sleeve having a first side and a second side, the insert sleeve including a first side large diameter section, a small diameter section and a second side large diameter section, with the insert sleeve having an insert sleeve enlarged lip at the second side thereof; and
an adjustment sleeve having a first side and a second side, the adjustment sleeve including a cylinder having an outer surface, the outer surface of the cylinder of the adjustment sleeve being smaller than an inner surface of the second side large diameter section of the insert sleeve to allow the first side of the adjustment sleeve to be able to be slid within the second side large diameter section of the insert sleeve;
the adjustment sleeve further including a ring seal surrounding the outer surface thereof, the ring seal not being fixed in position on the outer surface of the adjustment sleeve such that the ring seal is able to roll on the outer surface of the adjustment sleeve.

2. The pipe gap assembly of claim 1, wherein:
the insert sleeve includes a tapering section between the small diameter section and the second side large diameter section.

3. The pipe gap assembly of claim 2, wherein:
the insert sleeve includes a radially extending step between the small diameter section and the first side large diameter section.

4. The pipe gap assembly of claim 3, wherein:
the insert sleeve includes a radially extending seal on an exterior surface of the small diameter section.

5. The pipe gap assembly of claim 4, wherein:
the radially extending seal includes a cylindrical connection portion, a first radially extending disc seal portion extending radially from the cylindrical connection portion and a second radially extending disc seal portion extending radially from the cylindrical connection portion.

6. The pipe gap assembly of claim 5, wherein:
each of the first radially extending disc seal portion and the second radially extending disc seal portion have terminal edges that are beveled.

7. The pipe gap assembly of claim 1, wherein:
the insert sleeve includes a rolled edge forming the insert sleeve enlarged lip.

8. The pipe gap assembly of claim 1, wherein:
the second side of the adjustment sleeve includes an adjustment sleeve enlarged lip.

9. The pipe gap assembly of claim 8, wherein:
the adjustment sleeve includes a rolled edge forming the adjustment sleeve enlarged lip.

10. A pipe gap joint comprising:
a first pipe having a first pipe cylinder and a cylindrical edge;
a second pipe having a second pipe cylinder and a rolled edge;
an insert sleeve having a first side inserted into the first pipe at the cylindrical edge and a second side, the insert sleeve including a first side large diameter section, a small diameter section and a second side large diameter section, with the insert sleeve having an insert sleeve enlarged lip at the second side thereof; and
an adjustment sleeve having a first side inserted into the second side of the insert sleeve and a second side, the adjustment sleeve including a cylinder having an outer surface and an adjustment sleeve enlarged lip at the second side thereof, the adjustment sleeve enlarged lip abutting the rolled edge of the second pipe;
the adjustment sleeve further including a ring seal surrounding the outer surface of the cylinder thereof, the ring seal not be fixing in position on the outer surface of the adjustment sleeve such that the ring seal is able to roll on the outer surface of the adjustment sleeve, the ring seal abutting the insert sleeve enlarged lip.

11. The pipe gap joint of claim 10, further including:
a first clamp surrounding the insert sleeve enlarged lip and the ring seal to connect the insert sleeve to the adjustment sleeve; and
a second clamp surrounding the adjustment sleeve enlarged lip and the rolled edge of the second pipe to connect the adjustment sleeve to the second pipe.

12. The pipe gap joint of claim 10, wherein:
the first pipe and the second pipe are spiral pipes each including a circumferential spiral.

13. The pipe gap joint of claim 10, wherein:
the insert sleeve includes an insert sleeve rolled edge forming the insert sleeve enlarged lip; and
the adjustment sleeve includes an adjustment sleeve rolled edge forming the adjustment sleeve enlarged lip.

14. The pipe gap joint of claim 10, wherein:
the insert sleeve includes a radially extending seal on an exterior surface of the small diameter section.

15. The pipe gap joint of claim 14, wherein:
the radially extending seal includes a first radially extending disc seal portion and spaced second radially extending disc seal portion.

16. A method of forming a pipe gap joint comprising:
providing a first whole pipe having a first whole pipe cylinder and a pair of first pipe rolled edges;
cutting the first whole pipe to form a pair of first cut pipes, each of the first cut pipes including a cylindrical cut edge;
providing a second pipe having a second pipe cylinder and a second pipe rolled edge;
providing an insert sleeve having a first side and a second side, the insert sleeve including a first side large diameter section, a small diameter section and a second side large diameter section, with the insert sleeve having an insert sleeve enlarged lip at the second side thereof;
inserting the first side of the insert sleeve into the first cut pipe at the cylindrical cut edge;
providing an adjustment sleeve having a first side and a second side, the adjustment sleeve including a cylinder having an outer surface and an adjustment sleeve enlarged lip at the second side thereof;
inserting the first side of the adjustment sleeve into the second side of the insert sleeve;
providing the adjustment sleeve with a ring seal surrounding the outer surface of the cylinder thereof;
rolling the ring seal on the outer surface of the adjustment sleeve until the ring seal abuts the insert sleeve enlarged lip; and
abutting the adjustment sleeve enlarged lip with the second pipe rolled edge.

17. The method of forming the pipe gap joint of claim 16, further including:
surrounding the insert sleeve enlarged lip and the ring seal with a first clamp to connect the insert sleeve to the adjustment sleeve; and
surrounding the adjustment sleeve enlarged lip and the second pipe rolled edge with a second clamp to connect the adjustment sleeve to the second pipe.

18. The method of forming the pipe gap joint of claim 16, wherein:
the insert sleeve includes an insert sleeve rolled edge forming the insert sleeve enlarged lip; and
the adjustment sleeve includes an adjustment sleeve rolled edge forming the adjustment sleeve enlarged lip.

19. The method of forming the pipe gap joint of claim 16, wherein:
the insert sleeve includes a radially extending seal on an exterior surface of the small diameter section.

20. The method of forming the pipe gap joint of claim 19, wherein:
the radially extending seal includes a first radially extending disc seal portion and spaced second radially extending disc seal portion.
